(19) United States
(12) Patent Application Publication
(10) Pub. No.: US 2011/0149693 A1
(43) Pub. Date: Jun. 23, 2011

(54) METHOD OF ACTIVE REMIDING WATER DRINKING

(76) Inventor: Yi-Chia LIAO, Shih Tan Hsiang (TW)

(21) Appl. No.: 12/640,010

(22) Filed: Dec. 17, 2009

(51) Int. Cl. G04B 47/00

(52) U.S. Cl. 368/10

(57) ABSTRACT

A method of active reminding water drinking to help people nowadays who often forget to drink water because of busyness or assist caregivers of senior and aged people and patients to record regular water drinking conditions. The method calculates total water drinking amount within a preset time period and a staged water drinking amount within a staged time period, and issues a reminding alert signal in the event of insufficient or excessive water drinking condition. Thus it helps users to develop a regular water drinking habit to maintain a healthy physical condition.

### FIELD OF THE INVENTION

The present invention relates to a method of reminding water drinking and particularly to a method of automatic reminding water drinking that calculates water drinking amount within a preset time period and issues alarm signals for insufficient or excessive water drinking condition.

### BACKGROUND OF THE INVENTION

According to medical reports, normal people have to produces at least 1500 milliliters of urine every day to maintain normal operation of body and keep urinary system in a healthy state. To meet this end, an adult is recommended to drink water of 2000 milliliters or more a day.

It is generally not recommended to drink the total amount of needed water at one time, but replenish the daily required amount of water regularly at a constant amount each time. However, people nowadays often are busy at work and not easy to maintain a habit of drinking water regularly at a constant amount. Moreover, many senior or aged people require assistance and care of other people. When caregivers are busy, to maintain regular water drinking habit is more difficult. This creates concerns and problems of caring the aged people (maintain regular excretion also is difficult). As a result, people's health condition could suffer.

### SUMMARY OF THE INVENTION

The primary object of the present invention is to provide a method of active reminding water drinking to help users to develop a healthy water drinking habit through a thoughtful and delicate fashion. The method provides a main function of calculating total water drinking amount within a preset time period and water drinking amount in each stage, issues reminding alert in the event of insufficient or excessive water drinking amount and informs users the water drinking condition.

Another object of the present invention is to provide a passive calculating function to allow users to press a pushbutton to count water drinking frequency to calculate water drinking amount.

The method according to the present invention includes the procedures as follow:

Step S1: set a total water drinking time period and a total water drinking amount within the total water drinking time period to get an average value thereof, and calculate a staged water drinking amount;

Step S2: a user starts drinking water, and counts water drinking amount each time and total water drinking amount in an automatic counting or passive counting manner after drinking water each time;

Step S3: compare whether water drinking amount each time at step S2 coinciding with the staged water drinking amount at step S1, and judge whether user's water drinking progress is normal, ahead or lagged, and generate actively a reminding alert signal; and

Step S4: finish counting water drinking amount by fulfilling the conditions set at step S3.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a procedure flowchart of the method of active reminding water drinking according to the present invention.

FIG. 2 is a schematic view of an embodiment of the structure for implementing the present invention.

FIG. 3 is a schematic view of device configuration according to the present invention.

### DETAILED DESCRIPTION OF THE PREFERRED EMBODIMENT

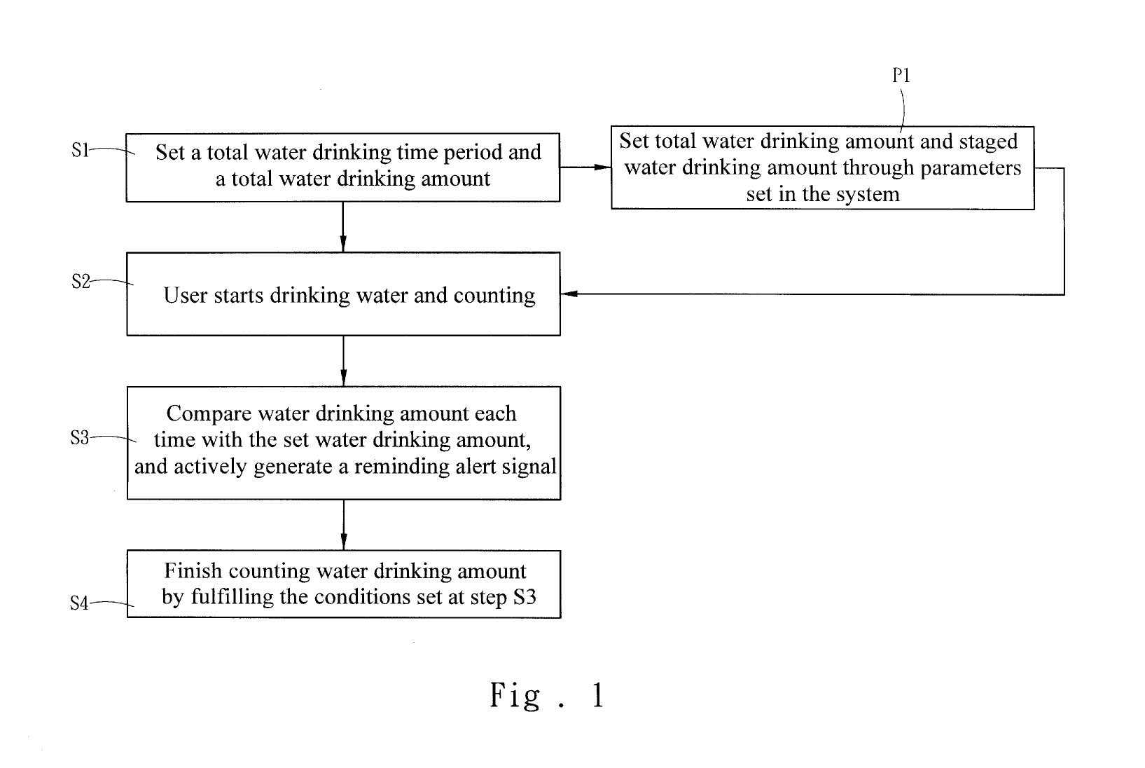

Please refer to FIG. 1 for the implementation procedures of the method of the present invention. The method aims to calculate total water drinking amount of a user within a preset time period and actively remind the user the progress of the water drinking amount in each stage. The method includes steps as follow:

Step S1: set a total water drinking time period and a total water drinking amount within the total water drinking time period to get an average value thereof and also calculate a staged water drinking amount;

Step S2: a user starts drinking water, and count water drinking amount each time and total water drinking amount in an automatic counting or passive counting manner after drinking water each time;

Step S3: compare whether water drinking amount each time at step S2 coinciding with the staged water drinking amount at step S1, and judge whether user's water drinking progress is normal, ahead or lagged, and generate actively a reminding alert signal; and

Step S4: finish counting water drinking amount by fulfilling the conditions set at step S3

In addition, the step S1 further includes another step P1 in which no settings are made for total water drinking amount and staged water drinking amount, but they can set the total water drinking amount and staged water drinking amount through parameters set in the system. At step S4, different reminding alert signals are issued in the event that water drinking amount is excessive or insufficient within the staged time period.

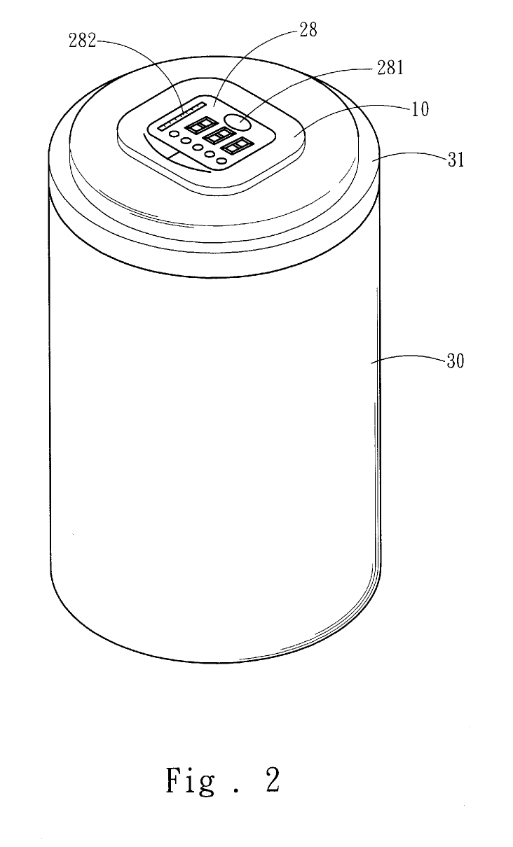

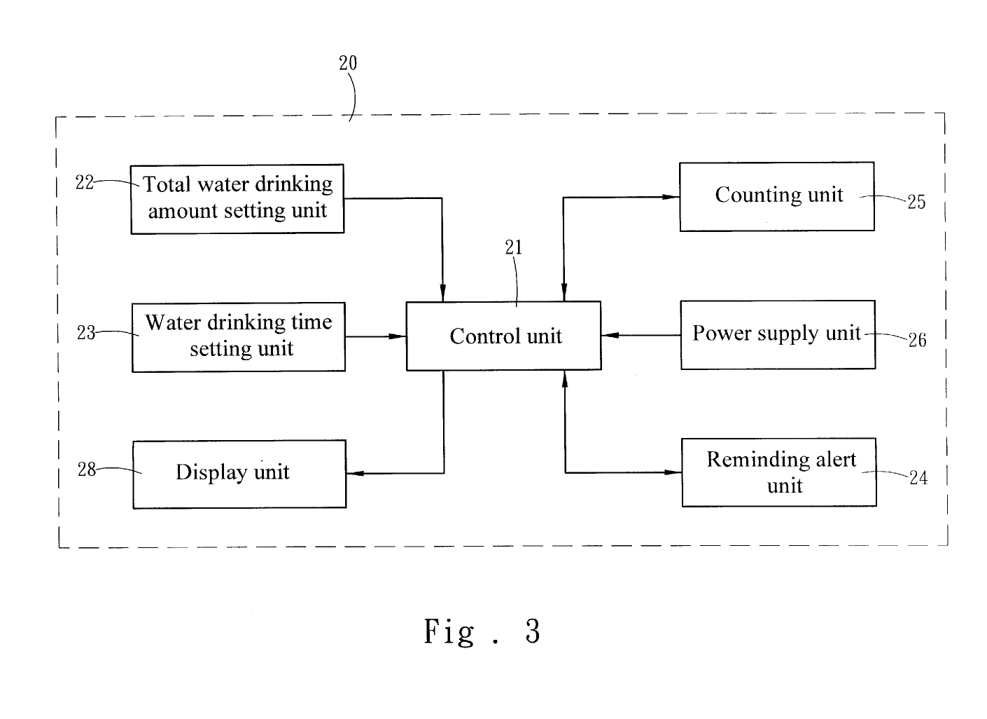

Please refer to FIGS. 2 and 3 for the structure and device configuration to implement the method of the present invention. The structure includes a microchip system 20 equipped with a case 10. The microchip system 20 is located on a cap 31 of a water drinking container 30. The microchip system 20 comprises a control unit 21, a total water drinking amount setting unit 22, a water drinking time setting unit 23 and a reminding alert unit 24.

Also referring to step S1, the total water drinking amount setting unit 22 is connected to the control unit 21 to perform calculation and inputs at least one total water drinking amount message. The water drinking time setting unit 23 is connected to the control unit 21 to perform calculation and inputs at least one water drinking time period message. The reminding alert unit 24 is connected to the control unit 21 to perform calculation, incorporating with step S3, in the event that water drinking standard is not met within the preset time period, the control unit 21 transmits a signal to the reminding alert unit 24 to generate at least one reminding alert signal. The reminding alert signal is generated by the calculation of linking control unit 21, total water drinking amount setting unit 22, water drinking time setting unit 23 and counting unit 25 to generate a water drinking time reminding alert and a water drinking amount reminding alert. The reminding alert unit 24 can generate different types of reminders and alerts according to insufficient or excessive staged water drinking amount. The staged water drinking amount is an accumulated water drinking amount or an average water drinking amount should be achieved within the staged time period. The reminders and alerts may be selected from a group consisting of sound, text, graphics, vibration or a combination thereof.

The control unit 21 is connected to the counting unit 25. The counting unit 25 provides an automatic amount counting function and a passive amount counting function. The automatic amount counting function is a sensing method selected from a group consisting of a probe sensing method, a weight sensing method, an infrared sensing method or a combination thereof to automatically sense water amount in the water drinking container 30. The passive amount counting function allows users to press a pushbutton 281 to count water drinking frequency, thereby to calculate water drinking amount.

Moreover, the control unit 21 also is respectively connected to a power supply unit 26 and a display unit 28 to perform calculation. The display unit 28 is located on an outer side of the case 10 and at least includes the pushbutton 281 and a progress display strip 282. The pushbutton 281 is connected to the counting unit 25, and the pushbutton 281 is activated when the passive amount counting function is used. The progress display strip 282 is provided to show the total water drinking amount message. The display manner of the display unit 28 is selected from a group consisting of numerals, graphics, text or a combination thereof.

Refer to FIGS. 1, 2 and 3 for an example. Given 3000 milliliters as a user's total water drinking amount needed in a period of eight hours in one day as a standard. Enter 3000 milliliters, 8 hours and information about total water drinking amount and staged water drinking amount of each drinking time period to the total water drinking amount setting unit 22 and water drinking time setting unit 23. Assumed setting eight hours as water drinking time period, drinking water once per hour, namely drinking 375 milliliters of water each hour. Set the counting unit 25 in the automatic counting operation mode. After the setting is finished, execute step S2 and start amount and time counting. Step S3 judges whether total water drinking amount and staged water drinking amount are accomplished within the preset time period. If the user regularly drinks 375 milliliters of water each hour, the control unit 21 and progress display strip 282 present the total water drinking amount message. The control unit 21 orders the reminding alert unit 24 to generate a water drinking progress conformation indication. In the event that the user drinks an excessive amount of water at the staged time period, the reminding alert unit 24 generates a water over-drinking reminding alert; on the other hand, if the user drinks an insufficient amount of water at the staged time period, the reminding alert unit 24 generates a water drinking insufficient reminding alert. Therefore, the process and method set forth above can help the user to manage healthy water drinking habit.

The user can also select the passive amount counting function as required. Each time the user drinks water, the pushbutton 282 is pressed manually to count water drinking amount by pressing frequency. By setting of the total water drinking amount setting unit 22 and water drinking time setting unit 23, the control unit 21 can perform calculation and comparison, and through the progress display strip 282 to present the total water drinking amount message at a given time to keep the user informed. The control unit 21 and the reminding alert unit 24 also generate reminding alerts of water drinking progress conformation, excessive water drinking and insufficient water drinking. Thus when the user is in the excessive or insufficient water drinking condition, namely water drinking does not perform regularly at a desired amount can be timely alerted to the user via the reminding alert unit 24. As a result, a healthy water drinking practice can be accomplished.

As a conclusion, the present invention provides a method of active reminding water drinking that sets total water drinking amount and staged water drinking amount within a preset time period to remind and alert users in excessive water drinking or insufficient water drinking condition. The present invention also provides a passive amount counting approach to keep users informed of their water drinking amount in the preset time period. It is a thoughtful and delicate approach to help the users to develop a healthy water drinking habit, and also help caregivers to take care of several senior and aged people or patients at one time to drink proper amount of water and record accurate water drinking amount to improve nursing quality.

What is claimed is:

1. A method of active reminding water drinking including a water drinking container which contains a microchip system to actively issue a reminding alert according to water drinking amount of a user to inform the user water drinking progress, comprising the steps of:
S1: setting a total water drinking time period and a total water drinking amount within the total water drinking time period, calculating an average value from the total water drinking amount and the total water drinking time period, and calculating a staged water drinking amount based on the average value;
S2: starting water drinking by the user and counting water drinking amount each time and the total water drinking amount by an automatic counting or passive counting manner after drinking water each time;
S3: comparing whether the water drinking amount each time at step S2 coinciding with the staged water drinking amount at step S1 to judge whether the water drinking progress of the user is normal, ahead or lagged and actively generating a reminding alert signal; and
S4: finishing counting the water drinking amount by fulfilling the conditions set at step S3.

2. The method of claim 1, wherein step S1 further includes a step P1 of not setting the total water drinking amount and the staged water drinking amount but setting the total water drinking amount and the staged water drinking amount through parameters set in the system.

3. The method of claim 1, wherein the staged water drinking amount is an accumulated total water drinking amount or an average water drinking amount reached within the staged time period.

4. The method of claim 1, wherein the reminding alert signal is selected from the group consisting of sound, text, graphics and vibration and a combination thereof.

5. The method of claim 1, wherein the automatic counting manner is a sensing method selected from the group consisting of probe sensing method, weight sensing method, infrared sensing method and a combination thereof.

6. The method of claim 1, wherein the counting manner is performed by the user pressing a pushbutton to count water drinking frequency to calculate the water drinking amount.
